(19) United States
(12) Patent Application Publication
(10) Pub. No.: US 2015/0309215 A1
(43) Pub. Date: Oct. 29, 2015

(54) Polarizing Sheet, Substrate Structure And Display Panel

(71) Applicants: BOE TECHNOLOGY GROUP CO., LTD., Beijing (CN); BEIJING BOE DISPLAY TECHNOLOGY CO., LTD., Beijing (CN)

(72) Inventors: Xin Gai, Beijing (CN); Minghui Zhang, Beijing (CN); Hui Zheng, Beijing (CN); Chunbing Zhang, Beijing (CN)

(21) Appl. No.: 14/316,022

(22) Filed: Jun. 26, 2014

(30) Foreign Application Priority Data
Apr. 24, 2014 (CN) 201410168142.9

(51) Int. Cl. G02B 1/16; G02B 5/30

(52) U.S. Cl. CPC G02B 1/16; G02B 5/30

(57) ABSTRACT

The invention provides a polarizing sheet, a substrate structure and a display panel. The polarizing sheet comprises an adhesive film, a first protection film, a polarization film, a second protection film and a surface protection film, wherein the adhesive film is a conductive adhesive film for exporting the static electricity generated by a corresponding substrate. In addition to a polarization function, the polarizing sheet or the substrate structure according to the invention also has a conduction function because it comprises a conductive adhesive film. Moreover, the polarizing sheet or the substrate structure according to the invention may simplify the realization process of electro-static discharge protection, the problem of poor fixing may be eliminated, and the problem of light leakage due to the fixing of a conductive gasket may be eliminated.

### CROSS REFERENCE OF THE RELATED APPLICATION

The present application claims priority to the Chinese application No. 201410168142.9 filed on Apr. 24, 2014, entitled with “Polarizing Sheet, Substrate Structure and Display Panel,” the entire contents of which are incorporated herein by reference.

### FIELD OF THE INVENTION

The present invention relates to the field of display technologies, and in particular, to a polarizing sheet, a substrate structure and a display panel.

### DESCRIPTION OF THE PRIOR ART

An Advanced-super Dimensional Switching (ADS) liquid crystal panel is in a horizontal field mode, and the picture quality is prone to be influenced by static electricity. If there exists no good output channel for the static electricity inside the panel, poor electro-static discharge (ESD) mura tends to occur, and in a severe case, the circuit structure in the liquid crystal panel may be burnt out. Therefore, the electro-static discharge protection of a liquid crystal panel appears especially important.

In an existing electro-static discharge protection mode, a transparent electrode layer (ITO) is formed on the outer surface of a color filter substrate, and then a conductive tape or a conductive gasket is attached to one side of the panel so as to connect the transparent conductive layer with a grounding piece (for example, a metal backplane or a conductive metal piece that is grounded, etc.) on the panel, thereby realizing grounding. As a result, the static electricity inside the panel may be exported, and an effect of electro-static discharge protection may be attained.

In the existing electro-static discharge method, because a conductive tape or a conductive gasket needs to be attached to one side of a panel, the realization process will certainly be complex, and additional attaching components will be added, thus the fixing will be unreliable. Moreover, other defects tend to occur, for example, L0 light leakage, and the picture quality will be influenced.

### SUMMARY OF THE INVENTION

In view of the above, the invention provides a polarizing sheet, a substrate structure and a display panel, thereby solving the problem of the prior art that the realization process of the electro-static discharge protection method is complex and the fixing effect is poor.

According to an embodiment of the invention, the invention provides a polarizing sheet, which comprises: an adhesive film, a first protection film, a polarization film, a second protection film and a surface protection film, wherein the adhesive film is a conductive adhesive film for exporting the static electricity generated by a corresponding substrate.

According to another embodiment of the invention, the adhesive film comprises: a coverage part corresponding to the substrate region and an extension part extending from the coverage part, wherein the extension part is used for grounding.

According to another embodiment of the invention, a part of the coverage part is a conductive adhesive film, and the extension part is a conductive adhesive film.

According to another embodiment of the invention, the whole coverage part is a conductive adhesive film, and the extension part is a conductive adhesive film.

According to another embodiment of the invention, the conductive adhesive film is a conductive adhesive filled with conductive particles.

According to an embodiment of the invention, the invention further provides a substrate structure, which comprises a substrate and the above polarizing sheet that is attached to the substrate.

According to another embodiment of the invention, the substrate comprises a display area and a non-display area.

The adhesive film of the polarizing sheet comprises: a coverage part corresponding to the substrate region and an extension part extending from the coverage part, wherein the extension part is used for grounding; the extension part is a conductive adhesive film, a part of the coverage part that corresponds to the non-display area is a conductive adhesive film, and a part of the coverage part that corresponds to the display area is a non-conductive adhesive film.

According to another embodiment of the invention, the substrate structure further comprises a conductive layer that is formed on the outer surface of the substrate, wherein the polarizing sheet is attached onto the conductive layer via the conductive adhesive film.

According to another embodiment of the invention, the substrate is an array substrate or a color filter substrate.

According to an embodiment of the invention, the invention further provides a display panel, which comprises the above substrate structure.

The above technical solutions of the invention have the following beneficial effects:

In addition to a polarization function, the polarizing sheet according to the invention also has a conduction function, because it comprises a conductive adhesive film. When the polarizing sheet is attached to a substrate, the conductive adhesive film may be directly employed to connect a corresponding grounding piece to realize grounding, without the need to additionally attach a conductive tape or a conductive gasket, thereby electro-static discharge protection of the substrate may be accomplished, the realization process of electro-static discharge protection may be simplified. Moreover the problem of poor fixing may be eliminated, and the problem of light leakage due to the fixing of a conductive gasket may be eliminated.

### BRIEF DESCRIPTION OF THE DRAWINGS

FIG. 1 is a schematic diagram showing the layered structure of a polarizing sheet according to one embodiment of the invention;

FIG. 2 is a top view showing one type of adhesive film of the polarizing sheet according to one embodiment of the invention; and

FIG. 3 is a top view showing another type of adhesive film of the polarizing sheet according to one embodiment of the invention.

### DETAILED DESCRIPTION OF THE PREFERRED EMBODIMENTS

In order to solve the problem that the realization process of the existing electro-static discharge protection method is complex and the fixing effect is poor, in the embodiments of the invention, a polarizing sheet containing a conductive adhesive film is employed to export the static electricity generated by a corresponding substrate, and the conductive adhesive film may be directly employed to connect a corresponding grounding piece, without the need to additionally attach a conductive tape or a conductive gasket. As a result, the realization process of electro-static discharge protection may be simplified, and the problem of poor fixing may de eliminated.

In order to make the technical problems to be solved, the technical solutions and the advantages of the invention more apparent, a detailed description will be given below in conjunction with the drawings and specific embodiments.

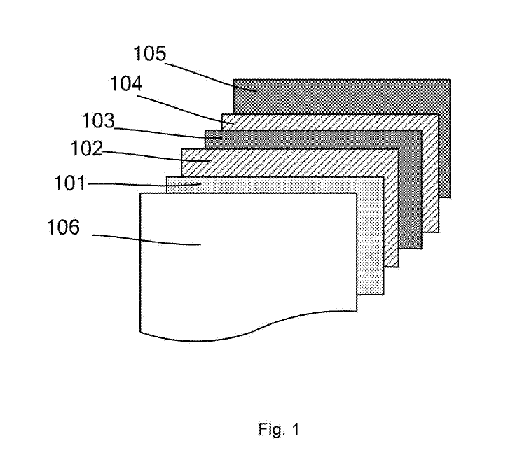

Referring to FIG. 1, it is a schematic diagram showing the layered structure of a polarizing sheet according to one embodiment of the invention. FIG. 1 is only used for describing the layered structure of a polarization layer, and it is a partial picture of a polarizing sheet, rather than showing the whole polarizing sheet.

The polarizing sheet according to the embodiment of the invention includes: an adhesive film 101, a first protection film 102, a polarization film 103, a second protection film 104 and a surface protection film 105. The adhesive film 101 is a conductive adhesive film for exporting the static electricity generated by a corresponding substrate. The substrate may be an array substrate or a color filter substrate.

The polarization film 103 is used for realizing a polarization function of the polarizing sheet, and the polarization film 103 may be formed of polyvinyl alcohol (PVA) or other materials.

The first protection film 102 and the second protection film 104 are provided on the two sides of the polarization film 103, for protecting the polarization film 103 from being influenced by external environments. The first protection film 102 and the second protection film 104 may be formed of triacetyl cellulose (TAC) or other materials.

The adhesive film 101 is provided on one side of the first protection film 102, for attaching the polarizing sheet onto the substrate and exporting the static electricity generated by the corresponding substrate.

The surface protection film 105 is provided on one side of the second protection film 104, for preventing that a scratch is left on the polarizing sheet while in use.

Additionally, the polarizing sheet according to the embodiment of the invention may further include a release film 106, which covers the adhesive film 101, for protecting the adhesive film 101. The release film 106 is only peeled off after the polarizing sheet is attached onto the substrate.

In addition to a polarization function, the polarizing sheet according to the invention also has a conduction function, because it comprises a conductive adhesive film. When the polarizing sheet is attached to a substrate, the conductive adhesive film may be directly employed to connect a corresponding grounding piece to realize grounding, without the need to additionally attach a conductive tape or a conductive gasket, thereby electro-static discharge protection of the substrate may be accomplished, the realization process of electro-static discharge protection may be simplified. Moreover, the problem of poor fixing may be eliminated, and the problem of light leakage due to the fixing of a conductive gasket may be eliminated.

The adhesive film 101 according to the embodiment of the invention may be a conductive adhesive filled with conductive particles.

The conductive adhesive may be a conductive double-faced adhesive tape or a conductive pressure-sensitive adhesive, etc.

The conductive double-faced adhesive tape is an adhesive that has a certain electrical conductivity after curing or drying. Conductive particles are combined together via the conglutination action of a base resin to form a conductive path.

The conductive pressure-sensitive adhesive (PSA) may be a solvent-type or emulsion-type adhesive from acrylic acid series and rubber series, and conductivity is realized by filling with conductive particles, for example, silver and copper particles, etc.

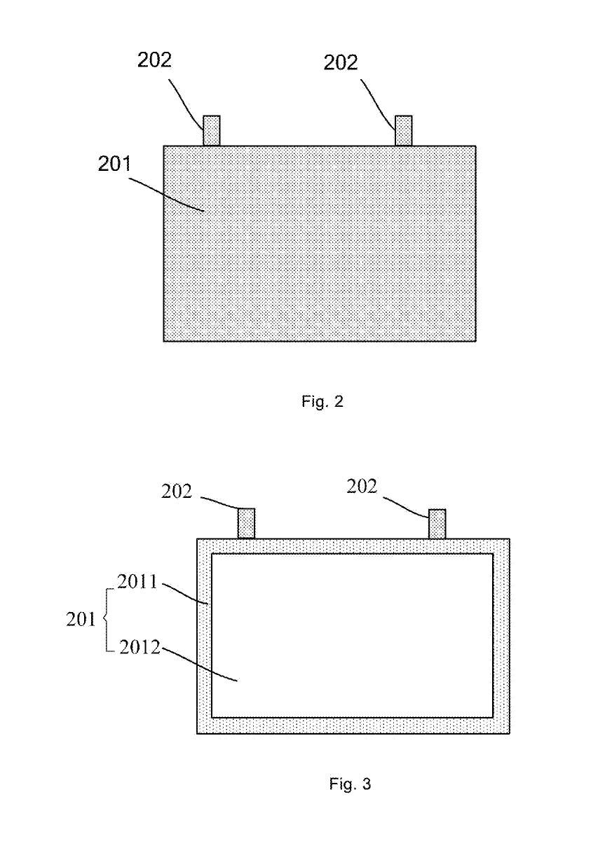

Referring to FIG. 2, it is a top view showing one type of adhesive film of the polarizing sheet according to one embodiment of the invention.

The adhesive film according to the embodiment of the invention includes: a coverage part 201 corresponding to the substrate region and two extension parts 202 extending from the coverage part 201, wherein the extension part 202 is used for grounding.

It should be noted that, the shape or the number of the extension parts 202 of the invention is not limited hereto, and the extension parts in the invention only show one specific implementation mode.

The whole coverage part 201 is a conductive adhesive film.

The extension part 202 is a conductive adhesive film. The extension part 202 may be directly attached onto a grounding piece of the panel to realize grounding. The grounding piece may be, for example, a metal piece that is grounded or a metal backplane of the panel.

In the embodiment shown in FIG. 2, the coverage part 201 and the extension part 202 are formed simultaneously.

In some other embodiments of the invention, the coverage part 201 may also be partially a conductive adhesive film and partially a non-conductive adhesive film.

Referring to FIG. 3, it is a top view showing another type of adhesive film of the polarizing sheet according to one embodiment of the invention.

The adhesive film according to the embodiment of the invention includes: a coverage part 201 corresponding to the substrate region and two extension parts 202 extending from the coverage part 201, wherein the extension part 202 is used for grounding.

A part 2011 of the coverage part 201 that corresponds to the non-display area of the substrate is a conductive adhesive film, and a part 2012 that corresponds to the display area of the substrate is a non-conductive adhesive film.

The extension part 202 is a conductive adhesive film. The extension part 202 may be directly attached onto a grounding piece of the panel to realize grounding. The grounding piece may be, for example, a metal piece that is grounded or a metal backplane of the panel.

In the embodiment shown in FIG. 3, a part 2011 of the coverage part 201 that corresponds to the non-display area of the substrate may formed simultaneously with the extension part 202, and a part 2012 of the coverage part 201 that corresponds to the display area of the substrate may be formed independently.

Or, the part of the coverage part that corresponds to the non-display area of the substrate, the part that corresponds to the display area of the substrate, and the extension part are formed simultaneously, and then conductive particles are filled on the part of the coverage part 201 that corresponds to the non-display area of the substrate and the extension part.

Under such a structure, a fluorescent material may be further added to the part 2011 of the coverage part 201 that corresponds to the non-display area of the substrate to realize logo display or other display effect.

Additionally, the shapes of the adhesive layers corresponding to the shape of each of other layers of the polarizing sheet are the same, which will not be illustrated again here.

According to one embodiment of the invention, the present invention further provides a substrate structure, which includes a substrate and a polarizing sheet that is provided on the substrate. The polarizing sheet includes an adhesive film, a first protection film, a polarization film, a second protection film and a surface protection film. The adhesive film is a conductive adhesive film for exporting the static electricity on the substrate.

The substrate is an array substrate or a color filter substrate.

The structure of the polarizing sheet is the same as that of the polarizing sheet according to the above embodiment, so no further detailed description thereof will be given here.

According to one embodiment of the invention, the substrate includes a display area and a non-display area, and the adhesive film of the polarizing sheet includes: a coverage part corresponding to the substrate region and an extension part extending from the coverage part, wherein the extension part is used for grounding; the extension part is a conductive adhesive film, a part of the coverage part that corresponds to the non-display area is a conductive adhesive film, and a part of the coverage part that corresponds to the display area is a non-conductive adhesive film.

In addition to a polarization function, the polarizing sheet according to the invention also has a conduction function, because it comprises a conductive adhesive film. When the polarizing sheet is attached to a substrate, the conductive adhesive film may be directly employed to connect a corresponding grounding piece to realize grounding, without the need to additionally attach a conductive tape or a conductive gasket, thereby electro-static discharge protection of the substrate may be accomplished, the realization process of electro-static discharge protection may be simplified. Moreover, the problem of poor fixing may be eliminated, and the problem of light leakage due to the fixing of a conductive gasket may be eliminated.

Additionally, the substrate structure according to the embodiment of the invention may further include a conductive layer that is formed on the outer surface of the substrate, wherein the polarizing sheet is attached onto the conductive layer. The conductive adhesive layer of the polarizing sheet is attached onto the conductive layer, and exports the static electricity on the substrate in coordination with the conductive layer. The conductive layer may be made of a transparent conductive material, for example, ITO, etc.

However, in order to lower the production cost, the substrate structure according to the embodiment of the invention may not include the conductive layer.

According to one embodiment of the invention, the invention further provides a display panel, which includes the substrate structure according to the above embodiment.

The display panel according to the embodiment of the invention may be an ADS-mode display panel, a TN-mode display panel or a display panel of other display modes.

For a panel of a frameless design or a narrow frame design, when a conductive tape or a conductive gasket is employed for grounding, it is very difficult to fix the conductive tape and the conductive gasket. However, in the embodiments of the invention, an extension part of a conductive adhesive film may be directly attached onto a corresponding grounding piece for grounding. Thus the polarizing sheet or the substrate structure according to the invention may be applicable to a panel of a frameless design or a narrow frame design.

The above description only shows some preferred embodiments of the invention. It should be noted that, for one of ordinary skills in the art, various improvements and modifications may be further made without departing from the principles of the invention. Moreover, all these improvements and modifications should be construed as the protection scope of the invention.

What is claimed is:

1. A polarizing sheet, comprising: an adhesive film, a first protection film, a polarization film, a second protection film and a surface protection film, wherein the adhesive film is a conductive adhesive film for exporting the static electricity generated by a corresponding substrate.

2. The polarizing sheet according to claim 1, wherein, the adhesive film comprises a coverage part corresponding to a region of the substrate and an extension part extending from the coverage part, and the extension part is used for grounding.

3. The polarizing sheet according to claim 2, wherein, a part of the coverage part is a conductive adhesive film, and the extension part is a conductive adhesive film.

4. The polarizing sheet according to claim 2, wherein, the whole coverage part is a conductive adhesive film, and the extension part is a conductive adhesive film.

5. The polarizing sheet according to claim 1, wherein, the conductive adhesive film is a conductive adhesive filled with conductive particles.

6. A substrate structure, comprising a substrate and the polarizing sheet according to claim 1 that is attached to the substrate.

7. The substrate structure according to claim 6, wherein:
the substrate comprises a display area and a non-display area;
the adhesive film of the polarizing sheet comprises: a coverage part corresponding to a region of the substrate and an extension part extending from the coverage part, and the extension part is used for grounding.

8. The substrate structure according to claim 7, wherein, the extension part is a conductive adhesive film, a part of the coverage part that corresponds to the non-display area is a conductive adhesive film, and a part of the coverage part that corresponds to the display area is a non-conductive adhesive film.

9. The substrate structure according to claim 6, wherein, the conductive adhesive film is a conductive adhesive filled with conductive particles.

10. The substrate structure according to claim 7, wherein, the conductive adhesive film is a conductive adhesive filled with conductive particles.

11. The substrate structure according to claim 8, wherein, the conductive adhesive film is a conductive adhesive filled with conductive particles.

12. The substrate structure according to claim 6, further comprising: a conductive layer that is provided on the outer surface of the substrate, and the polarizing sheet is attached onto the conductive layer via the conductive adhesive film.

13. The substrate structure according to claim 6, wherein, the substrate is an array substrate or a color filter substrate.

14. The substrate structure according to claim 7, wherein, the substrate is an array substrate or a color filter substrate.

15. The substrate structure according to claim 8, wherein, the substrate is an array substrate or a color filter substrate.

16. The substrate structure according to claim 9, wherein, the substrate is an array substrate or a color filter substrate.

17. The substrate structure according to claim 12, wherein, the substrate is an array substrate or a color filter substrate.

18. A display panel, comprising the substrate structure according to claim 6.
